(19) United States
(12) Patent Application Publication
(10) Pub. No.: US 2005/0194434 A1
(43) Pub. Date: Sep. 8, 2005

(54) Business card having a printed circuit board substrate and onboard electronic circuitry

(76) Inventor: Jimmy Lee Trent JR., Lindon, UT (US)

Correspondence Address: Angus C. Fox, III, 4093 N. Imperial Way, Provo, UT, 84604-5386, US

(21) Appl. No.: 10/794,732

(22) Filed: Mar. 4, 2004

(51) Int. Cl. G06K 5/00; G06K 19/06

(52) U.S. Cl. 235/380; 235/492

(57) ABSTRACT

An electronic business card includes a printed circuit board, having a desired length and width, as well as front and rear major surfaces, functions as the substrate of the business card. Electrical components, a switch, and a direct-current source, such as a battery or voltage cell, are mounted to the printed circuit board. The electrical components, the direct current source and conductive elements of the printed circuit board cooperate to provide a desired circuit functionality powered by the direct-current source. The switch permits power supplied by the direct-current source to be selectively disconnected from the electrical components. For one embodiment of the invention, the direct-current source is a laminar, surface mounted battery that is attached to the rear major surface. The electrical components may include light emitting diodes, as well as flasher, audio and video componentry.

### BACKGROUND OF THE INVENTION

1. Field of the Invention

This invention relates to electronic business cards and, more particularly, a business-card-sized printed circuit board on which various circuit components are mounted.

2. Description of the Prior Art

Business cards are typically printed on rectangular pieces of paper card stock measuring about 2 inches by 3½ inches. Each business card is typically associated with a single individual. The name of the individual, the name of the business which he represents, a brief description of the business, and contact information is generally printed on only one of the card's major faces. Business cards are used worldwide both as identifiers of the presenter and as a token of agency. They are presented to customers when a first contact is initiated, and they exchanged between colleagues at business meetings, conventions, and social events.

One of the problems associated with typical paper business cards is that the amount of product or business information that can be contained thereon is strictly limited by the size of the card. During the past decade, many attempts have been made to improve on the basic business card by making it both more memorable and a purveyor of greater amounts of business or sales-related information.

One solution to the limited amount of data was the trimming of a standard 5¼-diameter CD-ROM disc into a rectangular, card-sized lamina having a central aperture that could be played on the CD-ROM drive of a personal computer. On a 2 inch by 3.2 inch CD-ROM card, it is possible to store approximately 100 megabytes of data. This is equivalent to about 3,000 pages of single-spaced text, 11.4 minutes of uncompressed digital music, or about 3 minutes of digital audio-visual presentation. This represents a quantum leap in data storage ability. The only drawback is that a computer is required to access the digital data. The face of the CD-ROM card can, of course, carry conventional printed identity information. CD-ROM cards of this type are disclosed in the following U.S. Pat Nos. D429,733 to Rick E. Jones, et al.; D442,969, D445,767 and D447,146 to Douglas A. Myers; and D462,972 to Stephen O. Smyth, et al.

U.S. Pat. No. 6,616,052 to Tzu-Feng Tseng, et al. adds a magnetic strip to the type of CD-ROM business cards identified above. The magnetic strip may also be encoded with digital data, and must be read in a magnetic card reader.

More than fifteen years ago, Information Storage Devices (now a subsidiary of Winbond Electronics Corporation) developed ChipCorder® technology which permitted analog sound data to be stored within a EEPROM by recognizing 256 distinct voltage levels on the floating gate of a single EEPROM storage cell. This technology allowed voice and music sounds to be compactly and permanently (for up to 100 years) stored in analog format without the need for analog-to-digital conversion when recording the data and digital-to-analog conversion when playing the recorded data. This technology was ideal for a broad spectrum of consumer, security, industrial and automotive applications requiring voice capture and playback, voice annunciation of prompts and alerts, and multi-language personalization of electronic products. The new technology spawned a host of consumer applications, including inexpensive personalized greeting cards and talking toys. Some of those consumer goods were the subjects of patents.

U.S. Pat. No. 5,365,686 to James G. Scott discloses a picture holder having a recorder/playback integrated circuit. A preferred embodiment of the picture holder contains a DC voltage source, a speaker, and record and playback circuitry. An analog EEPROM sound recording chip is mounted on the picture, which plugs into the record and playback circuitry.

U.S. Pat. No. 5,480,156 to Doederlein, et al. discloses a squeezable talking trading card capable of generating an audio message including a thin housing having front and back surfaces, flexible sheets having indicia affixed to the front and back surfaces of the housing, a voice chip located in the housing for generating a given message, a battery for supplying electrical power to the voice chip, and a switch located in the housing for activating a voice chip.

U.S. Pat. No. 5,588,678 to Young discloses a talking trading card having two printed trading cards attached to the top and bottom sides of a substrate in which is housed the mechanism for powering, storing, activating and emitting a recorded sound and/or message. The audio message may be pre-recorded in a voice chip or may be programmed into the voice chip after the manufacture of the talking card through a receptacle placed on the side of the talking card.

U.S. Pat. No. 5,836,616 to David S. Cooper discloses a talking business card. However, rather than being a business card per se, it is actually a business card holder having voice record and playback capability. Though remarkably similar to the Scott device described above, the Scott patent was never considered during the examination of the Cooper application.

Other types of electronic business cards and readers for electronic business cards has been proposed.

U.S. Pat. No. 5,493,105 discloses a business card having printed data on the front major face and a magnetic data strip on the rear major face thereof. Information contained in the magnetic data strip can be read with a magnetic card reader.

U.S. Pat. No. 6,254,001 describes a reader for business cards which incorporate a magnetic data strip thereon. The reader, which has a display screen and control buttons, allows information to be transferred from such a business card to the memory of the reader.

U.S. Pat. No. D333,298 shows an electronic digital business card that has the appearance of a mini-laptop computer.

One of the major obstacles to manufacturing a thin electronics business card is the availability of a thin power source. Button cells and batteries, though typically less than 3 millimeters in thickness, typically require a holder having an additional added thickness of about 1 millimeter. The combined thickness of 4 millimeters must be added to any card substrate.

Although flat cell batteries were developed half a century ago (see U.S. Pat. No. 2,880,259 to Nowotny), many of the developments in thin laminar batteries were made by Polaroid Corporation. Edwin Land, the founder of Polaroid Corporation, invented or co-invented numerous types of thin laminar batteries for use in instant film packs. For example, U.S. Pat. No. 3,833,427 discloses a relatively thin, flat or planar battery which includes one or more cells in series relationship with a planar cathode and a separator disposed intermediate and extending substantially coextensive the facing surfaces of the anode and cathode and possessing marginal portions and an aqueous electrolyte permeable central portion. A further example is U.S. Pat. No. 4,007,472, which discloses a planar battery suited for photographic applications. Although the early thin laminar batteries employed cathode strata slurries and aqueous electrolytes, recent developments in the field of thin laminar batteries have eliminated the slurries and the leakage problems associated therewith.

One of the exciting recent developments is that of “printed” batteries, such those developed by Power Paper, a privately held company founded in 1997 and based in Israel. Just 0.5 to 0.7 millimeters in thickness, the ultra-thin flexible batteries can be printed on packages like ink and have very nearly linear discharge capacity. This technology is covered by U.S. Pat. No. 5,897,522 to Zvi Nitzan. This reference is incorporated herein, in its entirety, by reference. Another significant development is that of batteries based on dry solid polymer electrolyte technology. Although the idea has been around for some twenty years and was the subject of U.S. Pat. No. 4,520,086 to Terji Skotheim, the technology has been perfected over the years. U.S. Pat. No. 6,664,006 to M. Zafar A. Munshi discloses an all-solid-state electrochemical cell/battery having very thin film, high-conductive polymeric electrolyte and very thin electrode structures. Using the technology, lithium and lithium-ion cells and batteries can be manufactured that resemble a sheet of plastic. The foregoing two patent references are also incorporated herein, in their entirety, by reference.

### SUMMARY OF THE INVENTION

The present invention provides an electronic business card having an on-board DC power supply that is considerably thinner than those of the prior art. A printed circuit board having a desired length and width of a business card, as well as front and rear major surfaces, forms the body of the business card. The substrate of the printed circuit board may be fiberglass-reinforced epoxy plastic, fiberglass-reinforced polyester plastic, fiberglass-reinforced phenolic plastic, phenolic-impregnated paper, sheet Mylar®, sheet plastic unreinforced with fibers, glass, ceramics, or other similar appropriate material. The conductors on the printed circuit board may be formed from a metal foil made of aluminum, copper, gold, silver, or an alloy of any of those metals, a conductive epoxy (e.g., silver-filled epoxy), tin-doped indium oxide, zinc/tin co-doped indium oxide, a transition metal carbide (e.g., tungsten carbide), or a transition metal nitrides (e.g. titanium nitride). Electrical components selected to provide a desired functionality are preferably surface mounted to the printed circuit board using either solder or a conductive epoxy. A direct-current source, which is also mounted to the printed circuit board, and which may be one cell, multiple cells, or a battery, and provides power to the electrical components through conductors on the printed circuit board. For one embodiment of the invention, a flexible, laminar, surface-mounted battery is attached to the rear major surface of the printed circuit board substrate. The battery may use any of several available technologies, including dry solid polymer electrolyte and printable electrolytes and electrodes. A switch for selectively disconnecting power supplied by the direct-current source to the electrical components is also incorporated in the on-board circuitry.

The on-board electrical components may include one or more light-emitting diodes, and may also include flasher componentry for providing intermittent power to the one or more light-emitting diodes. The electrical components may also include an EEPROM in which sound data is stored in analog format, and a speaker which receives sound data from the EEPROM. Information Storage Devices, a subsidiary of Winbond Corporation of America, manufactures such EEPROMs under the brand name of ChipCorder®. The electrical components may also include a miniature video display, such as a mini liquid crystal display, for playing a video sequence stored electronically on the business card.

### BRIEF DESCRIPTION OF THE DRAWINGS

FIG. 1 is a top plan view, showing a first major surface, of a printed circuit board used as a business card substrate;

FIG. 2 is a bottom plan view, showing a second major surface, of the printed circuit board of FIG. 1;

FIG. 3 is a side elevational view of the printed circuit board of FIGS. 1 and 2;

FIG. 4 is a top plan view of the printed circuit board of FIG. 1 fully assembled with surface-mount electrical components;

FIG. 5 is a simplified block diagram of a flashing light-emitting diode circuit for use on a printed circuit board used as a business card substrate;

FIG. 6 is a simplified block diagram of a sound generating circuit for use on a printed circuit board used as a business card substrate;

FIG. 7 is a simplified block diagram of a video display circuit for use on a printed circuit board used as a business card substrate;

FIG. 8 is a simplified block diagram of combined sound generating and video display circuitry for use on a printed circuit board used as a business card substrate;

FIG. 9 is an isometric view of both a thin laminar battery and a printed circuit board used as a business card substrate, to which the thin laminar battery may be bonded; and

FIG. 10 is a side elevational view of the printed circuit board of FIGS. 1 and 2 following the printing of a battery on the underside thereof.

### DETAILED DESCRIPTION OF THE INVENTION

The present invention provides an DC-powered electronic business card that is considerably thinner than those of the prior art. One embodiment is currently being produced, and various other embodiments are contemplated. The various embodiments of the invention will now be described with reference to the attached drawing figures.

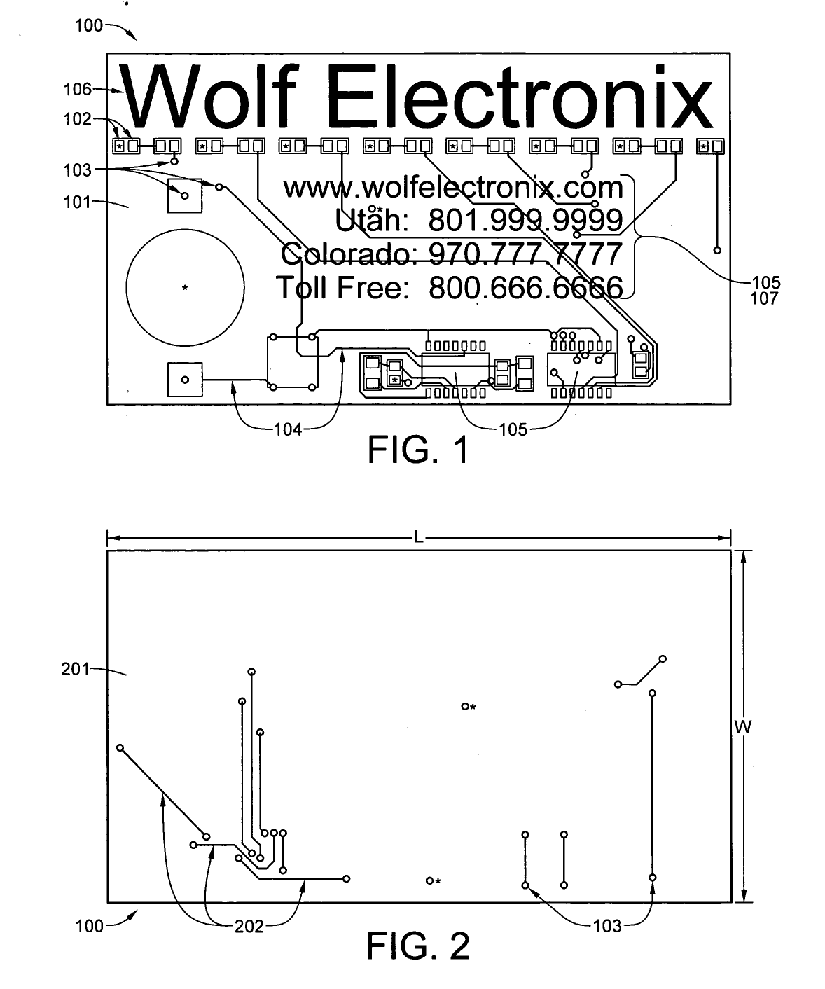

Referring now to FIG. 1, a dual-layer printed circuit board 100 is provided having on a front major surface 101 a plurality of tinned mounting pads 102 for surface-mount components. A plurality of plated through-holes 103 provide interconnections between non-ground conductors 104 on the front major surface and those on the lower major surface (not shown in this drawing figure). Pads and plated through holes 103 that are at ground potential are identified with an asterisk (*). Although in order to avoid unnecessary complexity, the ground plane conductor is not specifically shown in this drawing figure, it should be understood that it covers the majority of the upper major surface 101 and surrounds the non-ground conductors 104. Integrated circuit mounting locations 105 are also provided. A company name 106 may be printed on the upper major surface 101, as may be contact information 107.

Referring now to FIG. 2, the back major surface 201 of printed circuit board 100 is shown. The card has a desired length L and width W, which for a preferred embodiment of the business card are 3.5 inches (about 90 mm) and 2.0 inches (about 51 mm), respectively. Non-ground conductors 202 on the back major surface 201 are interconnected to conductors 104 on the upper major surface via the plated through-holes 103. Plated through holes 103 that are at ground potential are identified with an asterisk (*).

The printed circuit board 100 is fabricated from a substrate selected from the group consisting of fiberglass-reinforced epoxy plastic, fiberglass-reinforced polyester plastic, fiberglass-reinforced phenolic plastic, phenolic-impregnated paper, Mylar® (a polyethylene terephthalate polyester film developed by Dupont in the 1950s, and used for its high tensile strength, transparency and electrical insulation), sheet plastic unreinforced with fibers, glass, and ceramics. Conductors on the printed circuit board 100 are selected from the group consisting of metal foil, conductive epoxy, tin-doped indium oxide, zinc/tin co-doped indium oxide, transition metal carbides and transition metal nitrides. Tin-doped indium oxide and zinc/tin co-doped indium oxide are both transparent conductors. Use of such conductors can provide the illusion that the various components on the electronic business card are not interconnected.

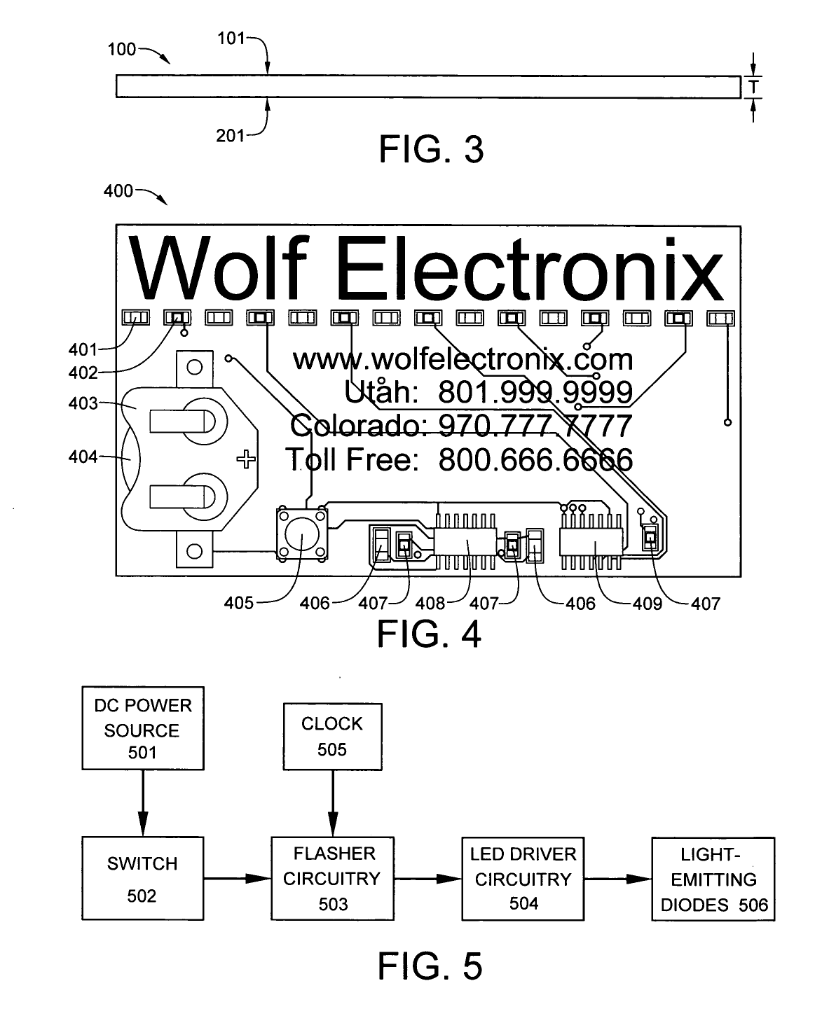

Referring now to FIG. 3, the printed circuit board 100 has a thickness T of about 0.0500 to 0.0625 inch (about 1.3 to 1.6 mm) when a fiberglass-reinforced polyester substrate is used. Other substrates, however, may be considerably thinner. For example, a printed circuit board substrate fabricated from Mylar® may be as thin as 0.005 inch (about 0.125 mm).

Referring now to FIG. 4, the completely assembled electronic business card 400 has a row of alternating light-emitting diodes 401 and resistors 402. A battery holder 403, which is surface mounted to the printed circuit board 100, holds a 3-volt coin cell 404. A normally-off switch 405 permits power to be selectively applied to the on-board circuitry. Flasher circuitry is constructed using a pair of capacitors 406, a trio of resistors 407, a first IC 408 providing quadruple 2-input positive NAND gates, and a second IC 409 providing 8-bit parallel-out serial shift registers. The circuit design is not deemed to be novel and, thus, will not be discussed in further detail.

Referring now to the simplified block diagram of FIG. 5, a flashing light-emitting diode circuit for use on a printed circuit board used as a business card substrate includes a DC power source 501, a normally-off switch 502, flasher circuitry 503 that is controlled by a clock 505, LED driver circuitry 504 that is controlled by the flasher circuitry 503, and at least one light-emitting diode 506 coupled to the LED driver circuitry 504.

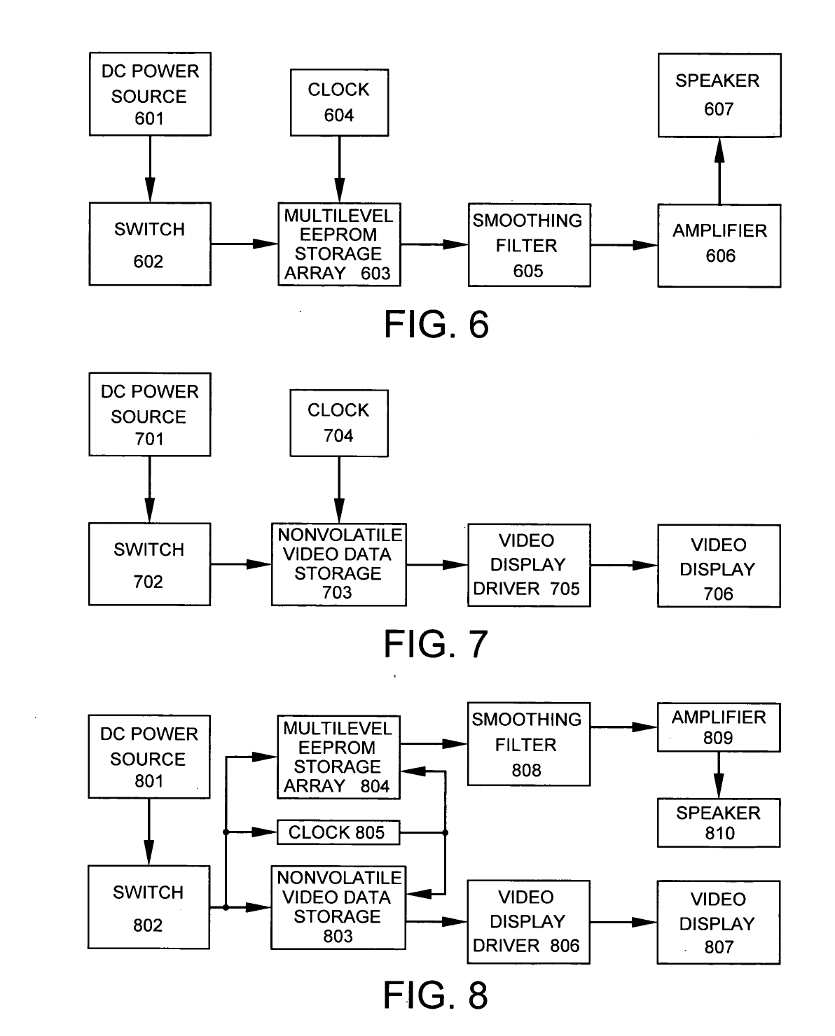

Referring now to the simplified block diagram of FIG. 6, a sound generating circuit for use on a printed circuit board used as a business card substrate includes a DC power source 601, a normally-off switch 602, a multi-level EEPROM storage array 603, a clock 604 for controlling the output from the multi-level EEPROM storage array 603, a smoothing filter 605 which smoothes the analog data flow from the multilevel EEPROM storage array 603, an amplifier 606 for amplifying the smoothed analog data flow from the smoothing filter 605, and a speaker 607 for generating audible sound. The multilevel EEPROM storage array 603 may be procured from Information Storage Devices, a subsidiary of Winbond Corporation of America that manufactures such EEPROMs under the brand name of ChipCorder®. Recording time of these components varies from 10 seconds for the least expensive components up to more than 10 minutes for considerably more expensive high-capacity components. A ChipCorder device, which includes both recording and playback circuitry, samples an incoming analog audio signal and stores the sampled data in serial analog format by using 24 levels of gate charge on each storage cell.

Referring now to the simplified block diagram of FIG. 7, a video display circuit for use on a printed circuit board used as a business card substrate includes a DC power source 701, a normally-off switch 702, nonvolatile video data storage 703, a clock 704 for controlling the output of data from the nonvolatile video data storage 703, a video display driver 705 which receives data from the nonvolatile video data storage 703 and drives the video display 706.

Referring now to the simplified block diagram of FIG. 8, a combined sound generating and video display circuitry for use on a printed circuit board used as a business card substrate includes a DC power source 801, a normally-off switch 802, a clock 805 which synchronizes data output from a multilevel EEPROM storage array 804 and a nonvolatile video data storage device 803, a smoothing filter 808 which smoothes the analog data flow from the multilevel EEPROM storage array 804, an amplifier 809 for amplifying the smoothed analog data flow from the smoothing filter 808, and a speaker 810 for generating audible sound, a video display driver 806 which receives data from the nonvolatile video data storage 803 and drives the video display 807.

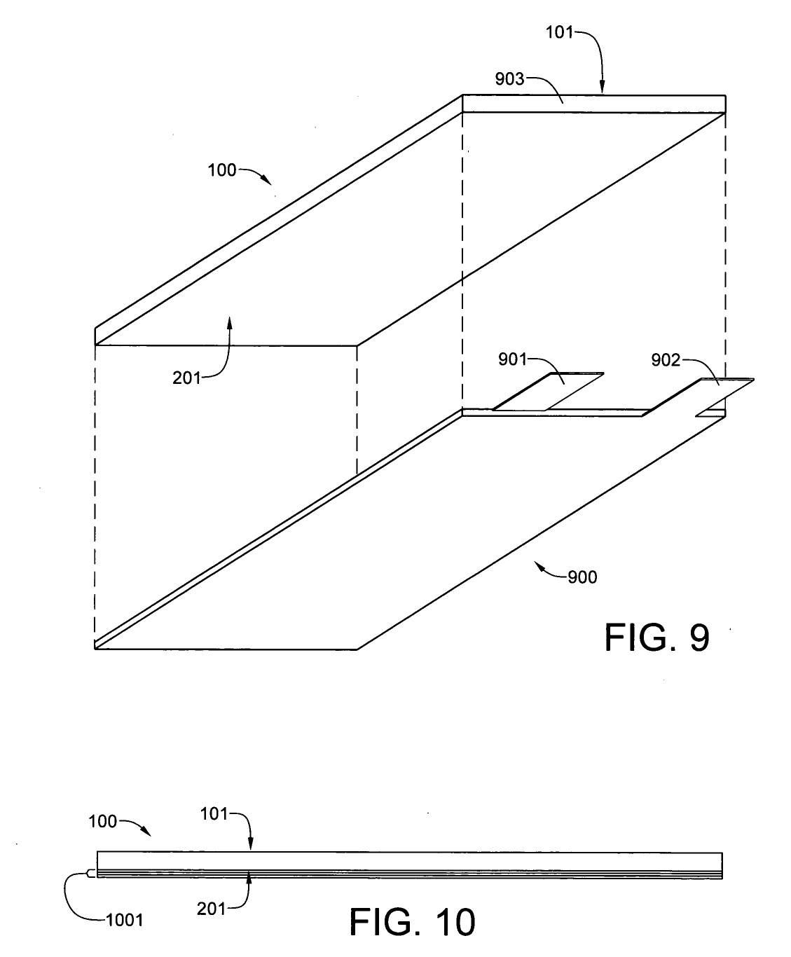

Referring now to FIG. 9, a thin laminar battery 900 is about to be adhesively bonded to the underside of the printed circuit board 100 of FIGS. 1 and 2. The positive and negative terminals 901 and 902, respectively, may be folded over the edge 903 of the printed circuit board 100 and soldered or conductively bonded to appropriate conductors on the upper surface 101. Silver-filled epoxy may be used to conductively bond the terminals 901 and 902 to the conductors. The battery may be a rechargeable lithium or lithium-ion cell or battery of a dry solid polymer electrolyte design, such as those offered by VoltaFlex Corporation. Such a cell or battery, based on eight years of research performed at the Massachusetts Institute of Technology, and proprietary VoltaFlex manufacturing processes, are made of flexible polymer materials. Alternatively, the battery may be based on the technology of U.S. Pat. No. 5,897,522, which discloses printable electrolytes and electrodes. Such a cell or battery may be formed independent of the substrate (printed circuit board) and then subsequently adhesively bonded to the substrate.

Referring now to FIG. 10, a battery, such as that disclosed in U.S. Pat. No. 5,897,522 has been printed on the underside of 201 of the printed circuit board 100. Other types of cells and batteries, appropriate for the application, may be employed. More types of appropriate cells and batteries are being developed with each passing year.

Although only several embodiments of the invention have been disclosed herein, it will be obvious to those having ordinary skill in the art that changes and modifications may be made thereto without departing from the spirit and scope of the invention as hereinafter claimed.

1. An electronic business card comprising:
a printed circuit board having a desired length and width of said business card, as well as front and back major surfaces;
electrical components mounted to said printed circuit board, said electrical components being selected to provide a desired functionality;
a direct-current source mounted to said printed circuit board, said direct-current source providing power to said electrical components through said printed circuit board in order to achieve said desired functionality, and
a switch for selectively disconnecting power supplied by said direct-current source to said electrical components.

2. The electronic business card of claim 1, wherein said printed circuit board includes a substrate selected from the group consisting of fiberglass-reinforced epoxy plastic, fiberglass-reinforced polyester plastic, fiberglass-reinforced phenolic plastic, phenolic-impregnated paper, polyethylene terephthalate polyester film, sheet plastic unreinforced with fibers, glass, and ceramics.

3. The electronic business card of claim 1, wherein said printed circuit board includes conductors selected from the group consisting of metal foil, conductive epoxy, tin-doped indium oxide, zinc/tin co-doped indium oxide, transition metal carbides and transition metal nitrides.

4. The electronic business card of claim 1, wherein said direct-current source is selected from the group consisting of a battery and a cell.

5. The electronic business card of claim 4, wherein said direct-current source is laminar, surface mounted, and attached to said back major surface.

6. The electronic business card of claim 5, wherein said direct-current source employs a dry solid polymer electrolyte.

7. The electronic business card of claim 4, wherein said direct-current source is laminar, having electrolytes and electrodes that are printed on said back major surface.

8. The electronic business card of claim 1, wherein said electrical components are surface mounted to said printed circuit board.

9. The electronic business card of claim 1, wherein said electrical components included at least one light emitting diode.

10. The electronic business card of claim 9, wherein said electrical components include flasher componentry for providing intermittent power to said at least one light emitting diode.

11. The electronic business card of claim 1, wherein said electrical components include an EEPROM in which sound data is stored in analog format and a speaker which receives sound data from said EEPROM.

12. The electronic business card of claim 1, wherein said electrical components include a liquid crystal display for playing a stored video message.

13. An electronic business card comprising:
a printed circuit board having a desired length and width of said business card, front and back major surfaces, and incorporating at least one layer of laminar conductors;
electrical components mounted to said printed circuit board, said electrical components being interconnected by at least some of said laminar conductors;
a direct-current source mounted to said printed circuit board, said direct-current source, said electrical components, and said laminar conductors cooperating to provide a desired circuit functionality powered by said direct-current source; and
a switch for selectively disconnecting power supplied by said direct-current source to said electrical components.

14. The electronic business card of claim 13, wherein said printed circuit board includes a substrate selected from the group consisting of fiberglass-reinforced epoxy plastic, fiberglass-reinforced polyester plastic, fiberglass-reinforced phenolic plastic, phenolic-impregnated paper, polyethylene terephthalate polyester film, sheet plastic unreinforced with fibers, and glass.

15. The electronic business card of claim 13, wherein said printed circuit board includes conductors selected from the group consisting of metal foil, conductive epoxy, tin-doped indium oxide, zinc/tin co-doped indium oxide, transition metal carbides and transition metal nitrides.

16. The electronic business card of claim 13, wherein said direct-current source is selected from the group consisting of a battery and a cell.

17. The electronic business card of claim 16, wherein said direct-current source is laminar, surface mounted, and attached to said back major surface.

18. The electronic business card of claim 17, wherein said direct-current source employs a dry solid polymer electrolyte.

19. The electronic business card of claim 16, wherein said direct-current source is laminar, having electrolytes and electrodes that are printed on said back major surface.

20. The electronic business card of claim 13, wherein said electrical components are surface mounted to said printed circuit board.

21. The electronic business card of claim 13, wherein said electrical components included at least one light emitting diode.

22. The electronic business card of claim 21, wherein said electrical components include flasher componentry for providing intermittent power to said at least one light emitting diode.

23. The electronic business card of claim 13, wherein said electrical components include an EEPROM in which sound data is stored in analog format and a speaker which receives sound data from said EEPROM.

24. The electronic business card of claim 13, wherein said electrical components include a liquid crystal display for playing a stored video message.

25. An electronic business card comprising:
a printed circuit board incorporating at least one layer of laminar conductors, said printed circuit board functioning as the electronic business card substrate;
electrical components mounted to said printed circuit board; and
a direct-current source mounted to said printed circuit board, said direct-current source, said electrical components, and said laminar conductors cooperating to provide a desired circuit functionality powered by said direct-current source.

26. The electronic business card of claim 25, wherein said printed circuit board includes a substrate selected from the group consisting of fiberglass-reinforced epoxy plastic, fiberglass-reinforced polyester plastic, fiberglass-reinforced phenolic plastic, phenolic-impregnated paper, polyethylene terephthalate polyester film, sheet plastic unreinforced with fibers, and glass.

27. The electronic business card of claim 25, wherein said printed circuit board includes conductors selected from the group consisting of metal foil, conductive epoxy, tin-doped indium oxide, zinc/tin co-doped indium oxide, transition metal carbides and transition metal nitrides.

28. The electronic business card of claim 25 wherein said direct-current source is a laminar, surface mounted battery that is attached to a back major surface of said printed circuit board.

29. The electronic business card of claim 25, wherein said direct-current source is a laminar, surface mounted battery employing a dry solid polymer electrolyte.

30. The electronic business card of claim 25, wherein said direct-current source is a laminar battery having electrolytes and electrodes that are printed on said back major surface.

31. The electronic business card of claim 25, wherein said electrical components are surface mounted to said printed circuit board.

32. The electronic business card of claim 25, wherein said electrical components include at least one light emitting diode.

33. The electronic business card of claim 32, wherein said electrical components include flasher componentry for providing intermittent power to said at least one light emitting diode.

33. The electronic business card of claim 25, wherein said electrical components include an EEPROM in which sound data is stored in analog format and a speaker which receives sound data from said EEPROM.

34. The electronic business card of claim 25, wherein said electrical components include a liquid crystal display for playing a stored video message.
